(19) United States
(12) Patent Application Publication
(10) Pub. No.: US 2010/0169791 A1
(43) Pub. Date: Jul. 1, 2010

(54) REMOTE DISPLAY REMOTE CONTROL

(76) Inventors: Trevor Pering, San Francisco, CA (US); Roy Want, Los Altos, CA (US); Kenton M. Lyons, San Jose, CA (US)

Correspondence Address: INTEL CORPORATION;c/o CPA Global, P.O. BOX 52050, MINNEAPOLIS, MN, 55402, US

(21) Appl. No.: 12/347,497

(22) Filed: Dec. 31, 2008

(51) Int. Cl. G06F 3/01

(52) U.S. Cl. 715/740; 715/781

(57) ABSTRACT

A Remote Display Protocol (RDP) server, such as a hand-held mobile device, may control various aspects of the RDP client, such as a large display. For example, if a user wishes to use a RDP system to project the display from their laptop computer onto a large-screen display mounted in a conference room, embodiments would allow the user to control aspects of the remote client such as location, size, and full-screen treatment.

### FIELD OF THE INVENTION

Embodiments of the present invention are directed to remote displays and, more particularly, to allowing multiple users simultaneous remote control of a larger display screen.

### BACKGROUND INFORMATION

The proliferation of computing technologies has increased consumer and business reliance on electronic manipulation and processing of a variety of data, including textual, graphic, and image information, on personal computers (PCs) and other mobile computers or web appliances such as personal digital assistants (PDAs), mobile internet devices (MIDs), ultra-mobile PCs (UMPCs), to name a few.

However, while these modern mobile devices possess great computation capabilities, their screen displays are relatively small compared with large-screen desktop displays and projector systems. Thus, it is often desirable for users of such devices to link to a larger remote display screen for ease of viewing or to share information with others. In a conference room situation, for example, a larger display may be present which is viewable by everyone in the room. Typically in this situation one of the participants may link their mobile device or PC to the large screen to share with the group.

Currently, remote display sharing from a server (i.e. the mobile device or PC) to a client (the larger service display mechanism) is typically done using a hard-wired cable, which only allows the client to display a full-screen version of the service display. So, if four people are sitting around a conference table and wish to share a remote large-screen display, then they would physically need to move the cable around between devices. This is obviously a very cumbersome proposition. Using the wireless features of the client changes this, but none of the current wireless remote display protocols (RDP) provides a mechanism to allow multiple people to coordinate the control of each wireless display onto a common large-screen display/projection system.

Furthermore, the basic usage model where four people are simultaneous sharing different parts of a remote display are not easily obtainable. The users would need access to the remote display (e.g., with a mouse), to position the client windows. Although this is certainly technically feasible, it would be very difficult and cumbersome to use and likely result in the users not using a RDP to share information among themselves.

Alternatively, the control of a RDP client requires access to the client machine itself. That is, either by another person sitting at the client, or a single user having access to the remote client. Of course, if the remote client is always run in full-screen mode this may not be an issue, but this restriction would severely limit the usefulness of remote display projection.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a a block diagram illustrating a source device (server) controlling the positioning of a display window on a client device such as a shared display; and

FIG. 2 is a block diagram showing multiple users or servers each controlling a window in a shared client display.

### DETAILED DESCRIPTION

Described is system that addresses the aforementioned problems by giving each server (i.e. PC or Mobile Device) wanting space on a client (i.e. larger display screen) separate remote control.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A remote display protocol (RDP) is a presentation protocol that enables a client device to exchange information with a server device over a network. The server device drives an application program in response to a command remotely input by the client device, and the client device displays the driven state of the application program provided from the server device.

Embodiments of the invention provide a mechanism for a Remote Display Protocol (RDP) server to control various aspects of the RDP client. For example, if a user wishes to use a RDP system to project the display from their laptop computer onto a large-screen display mounted in a conference room, this invention would allow the user to control aspects of the remote client such as location, size, and full-screen treatment.

Typically, RDP sessions are initiated from the client, allowing the user easy access and/or control over client operation. However, with the advent of highly-capability wireless MID platforms that are still nonetheless limited in their screen size, the ability to control a RDP client from the server (i.e. the MID) becomes more necessary, as users will more and more wish to use RDP protocols to project their mobile display onto a larger remote display using a wireless interface.

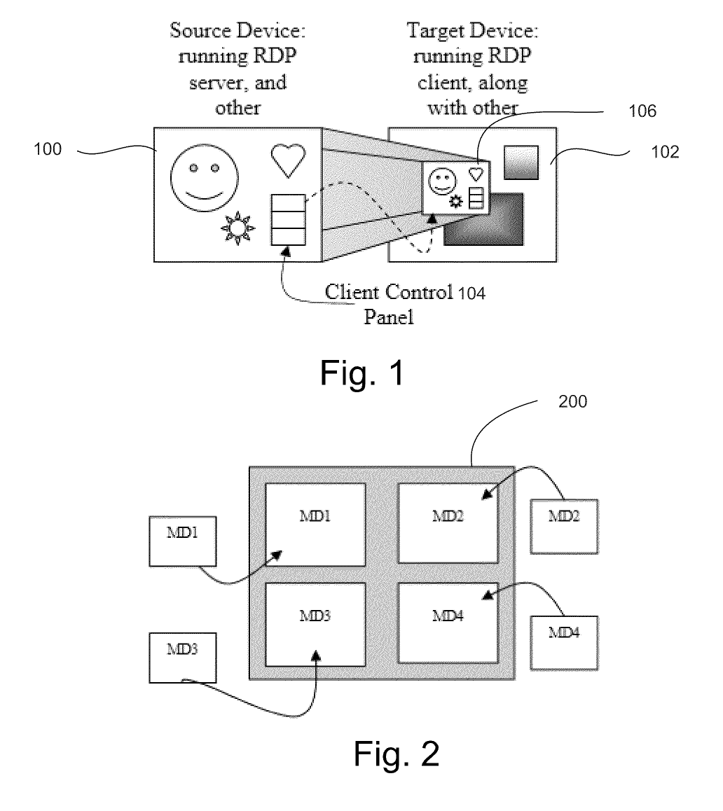

Embodiments of the invention comprise augmentations to the remote display protocol on the client and server to allow users to control the remote client. Referring to FIG. 1 there is shown a source device 100, such as a MID, running a RDP server as well as other applications. Also shown is a target device 102, such as a platform including a larger screen display, which is running an RDP client along with perhaps other applications. In one embodiment, the server side 100 may pop-up a small control window 104 that would allow a user at the server device 100 to control the client 102, thereby necessitating a change in the client 102 to allow it to be controlled remotely by the client 100. Thus, the display running on the server 100 may now be positioned also in the display of the client 102 in a window 106. According to one embodiment, the RDP is now augmented to allow the server 100 to send control commands back to the client 102. This involves a change to the protocol, but it would have a significant impact on the functionality of the system.

The user interface or control window 104, may for instance be composed of a plurality of widgets, wherein a widget is understood as an element of a user interface that displays information or provides a specific way for a user to interact with an application. Widgets may for instance comprise icons, pull-down menus, buttons, selection boxes, progress indicators, on-off checkmarks, scroll bars, windows, window edges (that allow a user to resize a window), toggle buttons, forms, and any other elements for displaying information and for inviting, accepting, and responding to user actions.

Referring to FIG. 2, in some cases, there may be multiple users connecting to the same remote display. In this example, there may be four mobile devices, labeled MD1, MD2, MD3 and MD4. According to one embodiment, this invention would allow each user an individual way to coordinate their actions. Consider the case where there are four people in a meeting each with the own mobile device (MD1-MD4), and they wish to share information from their mobile devices amongst themselves. To facilitate their interaction, all the users could connect to the remote display 200 using a suitably augmented RDP, and connect their devices, running a RDP server, to a RDP client on the remote display 200. For some kinds of sharing, they may wish to tile the clients so that all users can see scaled-down views of all the content on the mobile devices such as to enable comparisons, as shown. Each mobile device may choose the size and position of their own display window on the remote display 200 or, in other embodiments, the mobile devices may be able to control the size and position of other mobile device's display windows on the remote display 200. In other embodiments, a single user may wish to full-screen their display client so that only the contents of their particular mobile device are shown, maximizing the use of the remote screen real-estate.

Simple social conventions could be used to mediate access to the shared resource or display 200. For example, one wouldn't full-screen their particular presentation when somebody else is talking. Similar to many server-side mechanisms, the system may comprise client-side control options that allow/deny remote access to the client control. That is, it may not always be appropriate for a user at a server to control the accessing client. So, just as current servers often require a password in order to connect to the server, the client 200 may optionally request a password in order for the remote server to connect back to the accessing client.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a source device, comprising a computer running a remote display protocol (RDP) server application;
a first display associated with the source device to display source information;
a shared device, comprising a computer running a RDP client application;
a second display associated with the shared device; and
an interface associated with the source device to control the size and position of the source information on the second display.

2. The apparatus as recited in claim 1 wherein the source device is a mobile computer.

3. The apparatus as recited in claim 2 wherein the second display of the shared device is larger than the first display.

4. The apparatus as recited in claim 1 further comprising:
a plurality of source devices each having an interface to control the position of the source information on the second display.

5. The apparatus as recited in claim 1 wherein the source information from the first source display is repositioned based on information from a second source device.

6. The apparatus as recited in claim 4 wherein each of the plurality of sources devices displays source information in one of a plurality of tiled windows on the second display.

7. The apparatus as recited in claim 1 wherein the interface allows the client to control the position and size of the source information on the second display.

8. A method, comprising:
running a server remote display protocol (RDP) on a source device having a first display;
running a client RDP on a target device having a second display; and
controlling the positioning of information on the first display on the second display from the source device.

9. The method as recited in claim 8, wherein the source device is a mobile computer.

10. The method as recited in claim 8 wherein the second display is larger than the first display.

11. The method as recited in claim 8 further comprising:
sharing the second display amongst a plurality of source devices.

12. The method as recited in claim 11 further comprising:
allowing each of the plurality of source devices to control the positioning of a window amongst a plurality of windows on the second display.

13. The method as recited in claim 12 further comprising:
allowing each of the plurality of source devices to control the size of the window on the second display.

14. The method as recited in claim 8 wherein the source information from the first source display is repositioned based on information from a second source device.

15. The method as recited in claim 12 wherein the plurality of widows are tiled and each comprise a display from a different source device.

16. A system, comprising:
a mobile computing device having a smaller display for displaying information;
a target device comprising a larger display;
a remote display protocol (RDP) running on the mobile computing device and on the target device;
the RDP running on the mobile computing device providing an interface to allow a user to control the target device;
the RDP running on the target device providing a window to be displayed on the larger display containing the information from the mobile computing device.

17. The system as recited in claim 16, further comprising:
a plurality of mobile computing devices each having its own window for displaying information on the larger display.

18. The system as recited in claim 17 wherein each of the plurality of mobile computing devices controls the size and positioning of its own window on the larger display.

19. The system as recited in claim 16, wherein the target device requests a password from the source device.
